(19) United States
(12) Patent Application Publication
(10) Pub. No.: US 2026/0148039 A1
(43) Pub. Date: May 28, 2026

(54) AEROSPACE NAVIGATION DATA HARMONIZATION SYSTEMS AND METHODS

(71) Applicant: THE BOEING COMPANY, Arlington, VA (US)

(72) Inventors: Milind Vasudeo Naik, Frankfurt (DE); Pablo Costas Álvarez, Majadahonda (ES); Marko Zoricic, Dreieich (DE)

(73) Assignee: THE BOEING COMPANY, Arlington, VA (US)

(21) Appl. No.: 18/960,016

(22) Filed: Nov. 26, 2024

(51) Int. Cl. G06N 3/0442; G06N 3/084

(52) U.S. Cl. CPC G06N 3/0442; G06N 3/084

(57) ABSTRACT

An ASIC for an artificial neural network includes an array of neurons each including a register, processing element, and input; and synaptic circuits each including a memory for storing a synaptic weight. Each neuron is connected to another neuron via a synaptic circuit. The processing elements receive data sets from different providers, the data sets including data features representative of locations used in connection with flying aircraft. The processing elements examine the data features using the synaptic weights and the synaptic circuits to identify duplicative data features, select one or more of the duplicative data features for elimination based on prior selections; and send remaining data features to data consumers for use in flying or managing flight of one or more aircraft.

### FIELD OF THE DISCLOSURE

Examples of the present disclosure relate to handling aeronautical data from several different sources for use in planning flights and/or controlling aircraft during flights.

### BACKGROUND OF THE DISCLOSURE

Digital aerospace navigation data is information used by pilots and air traffic control prior to and during flights to ensure the flights are safe. This information can be used for planning flights, navigation (e.g., avoiding obstacles or other aircraft), performing emergency procedures during flights, and the like. This information can include electronic maps of airports, weather information, procedures for aircraft at airports, temporary hazards, air traffic control information, and the like.

Given the amount and detail of information needed for these uses, digital aerospace navigation data is complex in nature and massive in size when containing baseline information from airspace owners that is distributed to data aggregators. Currently, data providers only distribute aerospace navigation data during long cycles, such as once every twenty-eight days (with some occasional amendments between cycles for much smaller data sets).

With the introduction of the data standardizations like the Aeronautical Information Exchange Model (AIXM), however, updates to the aerospace navigation data within these types of models can occur much more frequently, and can be potentially unlimited in time and size. As one example, Eurocontrol in Europe distributes AIXM information (e.g., aerospace navigation data modified to the format of AIXM) ten times per day on an average.

Currently, the AIXM includes the following data features in the aerospace navigation data that is distributed from the model: navaids, routes, restrictions, airport-heliport locations, significant geographic points (i.e., waypoints and terminal points), runway locations, holding patterns, airspaces, airway locations and layouts, etc. The AIXM specifications allow universally unique identifiers (UUIDs) to be used to uniquely identify these data features. According to AIXM specifications, the UUID is assigned to the feature for the lifetime of that feature. Features at borders of countries, however, can be published by air navigation service providers (ANSPs) of two or more countries at or near these country borders. For example, waypoint data used by an airport in France can be published by ANSPs located in Switzerland, France, and Germany, but with different and distinct UUIDs.

These different UUIDs identifying the same feature can create a significant problem for consumers of the aerospace navigation data when distributing information from multiple ANSPs. Currently, there is no known cohesive solution to this problem and, as a result, overlapped and duplicate information can be distributed to final data consumers. This, in turn, can cause problems to customers when loading the overlapped and duplicate information into their navigation systems, especially navigation databases in equipment onboard aircraft.

Some known current systems may manually identify and rectify this type of overlapped and duplicate information. While this manual identification and rectification of duplicative information may be workable when the information updated on longer cycles (e.g., twenty-eight days or more), more frequent updates (e.g., several times per day) may make manual identification and rectification impossible to achieve.

### SUMMARY OF THE DISCLOSURE

In one example, an application-specific integrated circuit (ASIC) for an artificial neural network (ANN) is provided. The ASIC comprises: neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to: receive data sets from different providers, the data sets including data features representative of locations used in connection with flying aircraft; examine the data features using the synaptic weights and the synaptic circuits to identify duplicative data features among the data features from the data sets; select one or more of the duplicative data features for elimination from the data sets based on prior selections of the duplicative data features; and send remaining data features other than the one or more of the duplicative data features selected for elimination to one or more data consumers for use in flying or managing flight of one or more aircraft.

In another example, a method comprises: receiving data sets from different providers, the data sets including data features representative of locations used in connection with flying aircraft; examining the data features using one or more ASICs for an ANN, the one or more ASICs including neurons organized in an array, each of the neurons including a register, a processing element, and at least one input, the one or more ASICs also including synaptic circuits, each of the synaptic circuits including a memory for storing a synaptic weight, wherein each of the neurons is connected to at least one other of the neurons via at least one of the synaptic circuits, the data features examined using the synaptic weights and the synaptic circuits to identify duplicative data features among the data features from the data sets; selecting one or more of the duplicative data features for elimination from the data sets based on prior selections of the duplicative data features; and sending remaining data features other than the one or more of the duplicative data features selected for elimination to one or more data consumers for use in flying or managing flight of one or more aircraft.

In another example, an artificial intelligence system comprises: one or more ASICs, each of the ASICs comprising: neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to: receive data sets from different providers, the data sets including data features representative of locations used in connection with flying aircraft; examine the data features using the synaptic weights and the synaptic circuits to identify duplicative data features among the data features from the data sets; select one or more of the duplicative data features for elimination from the data sets based on prior selections of the duplicative data features by one or more analysts; and send remaining data features other than the one or more of the duplicative data features selected for elimination to one or more data consumers for use in flying or managing flight of one or more aircraft.

### BRIEF DESCRIPTION OF THE DRAWINGS

FIG. 1 illustrates one example of an aerospace navigation data harmonization system;

FIG. 2 illustrates one example of different data features that may be included in different data sets provided by different sources;

FIG. 3 illustrates one example of a machine learning/artificial intelligence system shown in FIG. 1.

FIG. 4 illustrates a flowchart of one example of a method for harmonizing aerospace navigation data.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

One or more examples of the inventive subject matter described herein provide systems and methods for harmonizing aerospace navigation data from different sources. The systems and methods can ingest multiple sets of aeronautical data from different providers, automatically detect geographical overlap in the data sets, and either combine or support the combining the data sets into a harmonized data set that is ready to be used by final data consumers. This harmonized data set may remove, resolve, or otherwise eliminate duplicate data within the different data sets to avoid interfering with the consumers'systems that rely on the data.

The systems and methods can handle duplicate data entries using artificial intelligence or machine learning systems and models that learn from detected duplicate data and previous handling decisions (e.g., decisions on how duplicate data previously was handled). The systems and methods can provide significant benefits in the aviation industry where data aggregators and sellers can benefit from collaborative and/or unattended but reliable and fast systems that detect overlaps in data distributed by ANSPs, while also being able to instantly or near instantly react to changes in the data.

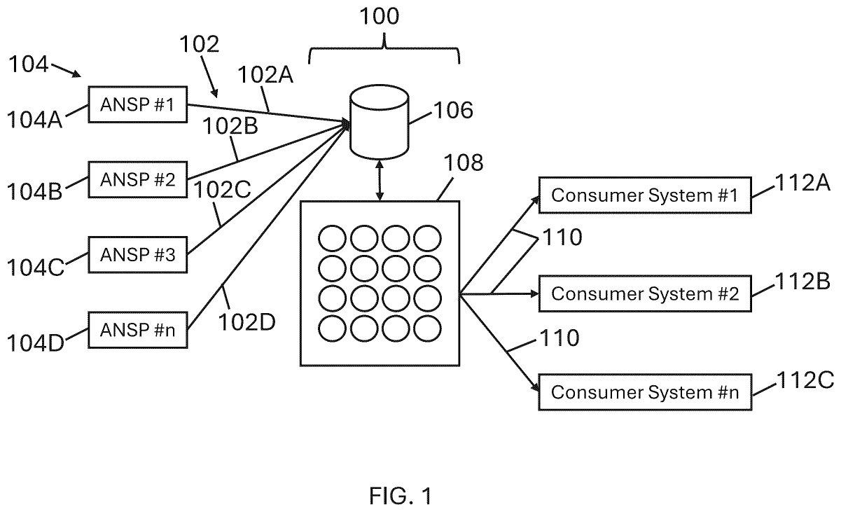

FIG. 1 illustrates one example of an aerospace navigation data harmonization system 100. The harmonization system 100 receives different data sets 102 (e.g., data sets 102A-D) from different sources 104 (e.g., sources 104A-D). In the illustrated example, the sources 104 represent different ANSPs. For example, one source 104A may represent an ANSP in one country (e.g., Germany), another source 104B may represent another ANSP in another country (e.g., France), another source 104C may represent another ANSP in another country (e.g., Austria), another source 104D may represent anther ANSP in another country (e.g., Italy), and so on. While four sources 104 are shown, alternatively, there may be fewer or more sources 104 providing data sets 102 to the harmonization system 100.

The sources 104 may be geographically near each other, such as by being located in different countries that share boundaries or that are closer to each other than other countries. The data sets 102 may include data features such as locations of navaids, routes, restrictions, airport-heliport locations, significant geographic points (i.e., waypoints and terminal points), runway locations, holding patterns, airspaces, airway locations and layouts, and the like. These data features may be associated with or identified by unique identifiers (e.g., UUIDs) that are assigned by the different sources 104. Some data features may be only included in the data set 102 provided by one source 104, while other data features may be included in multiple data sets 102.

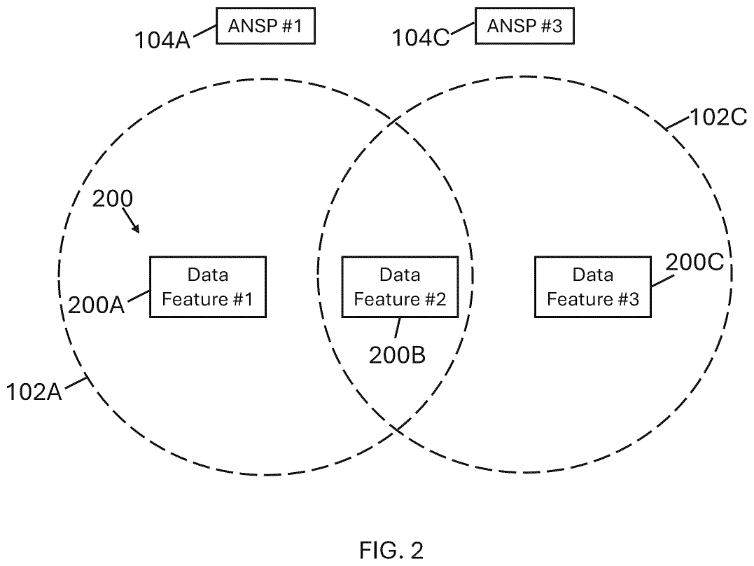

FIG. 2 illustrates one example of different data features 200 (e.g., data features 200A-C) that may be included in different data sets 102 provided by different sources 104. The data set 102A may be provided by the source 104A, while the data set 102C may be provided by the source 104C. The data set 102A may include several data features or entries 200, including a data feature 200A and a data feature 200B. These data features 200A, 200B can represent, for example, different airports in a geographic area associated with the data set 102A. The data set 102C may include several data features, including a data feature 200C and the data feature 200B. These data features 200B, 200C can represent, for example, different airports in a geographic area associated with the data set 102C.

The data feature 200B may be included in both data sets 102A, 102C. For example, the airport represented by the data feature 200B in the data sets 102A, 102C may be near a boundary between the countries where the sources 104A, 104C are located or affiliated with. But the sources 104A, 104C may assign different unique identifiers to this data feature 200B. The data set 102A may have a UUID of T4G1P ZWATZWAAAT SEEU for the data feature 200B while the data set 102C may have a UUID of T4G1P ZSQDZSCAA10 ZS SEEU for the same data feature 200B. There may be many more data features 200 included in both data sets 102A, 102C having different unique identifiers. Moreover, the identifier used for a data feature 200 appearing in multiple data sets 102 may change in one or more of these data sets 102 (while still being different or inconsistent through the different data sets 102). As a result, the data feature 200B is duplicated (e.g., is a duplicate) data feature in multiple data sets 102.

The harmonization system 100 can identify the duplicated data features 200 in different data sets. The harmonization system 100 includes one or more databases 106 that receive the data sets 102 from the sources 104, such as via one or more computerized wired and/or wireless communication networks. The data sets 102 may be received on a cyclical basis, such as once every two to three hours, several times a day, several times a week, and so on. Optionally, a data set 102 can be received that amends or modifies a previously submitted data set 102.

The harmonization system 100 includes an artificial intelligence machine learning (AI/ML) system 108 as described herein. The AI/ML system 108 can search for duplicated data features 200 in the received data sets 102. For example, the AI/ML system 108 can compare the identifiers (e.g., the UUIDs or other identifiers that are unique to the data set 102) in the data features 200 from different data sets 102. If the identifiers match, then the AI/ML system 108 can determine that the data features 200 having the matching identifiers are duplicative (e.g., represent the same location, waypoint, airport, etc.).

If the identifiers do not match, then the AI/ML system 108 can group the data features 200 into different groups by the AIXM features represented by the data features 200. The AIXM features may be different types of the locations. For example, airports may be one type of AIXM features, waypoints may be another type of AIXM features, and so on. After the data feature 200 are so grouped, the AI/ML system 108 can compare the natural keys of the data features in each group. Natural keys can be alphabetic, numeric, or alphanumeric strings within the data features that are meaningful values (not null values). The natural keys may not be unique to the data features. For example, two or more data features from different sources may include entire or partial natural keys that are the same or overlap.

The natural keys of each data feature in the group of data features 200 associated with runway locations can be compared with each other, the natural keys of each data feature in the group of data features 200 associated with holding pattern locations can be compared with each other, and so on. These natural keys can be compared to determine whether the data features 200 being compared are duplicative (e.g., represent the same thing) or different (e.g., represent different things).

The natural keys for different groups of data features 200 can be defined differently for different groups. For example, the natural keys for the airport group of data features 200 can be or can include the aeronautical radio incorporated (ARINC) code areas (e.g., the boundary relations of class ARINC and/or tailoring codes, the airport identification numbers (e.g., the airport codes such as STL for St. Louis Lambert airport, FRA for Frankfurt airport, and so on), the International Civil Aviation Organization (ICAO) region, or the International Air Transmission Association (IATA) identifications. One or more of these areas or codes may be included in the data features 200 and can be compared to each other to determine if there is a match. For example, if the natural keys for the data features 200 in different data sets 102 include the same airport code, include locations that are in the same ARINC areas or same ICAO regions, or the like, then the AI/ML system 108 may determine that the data features 200 are duplicative (e.g., represent the same airport). Otherwise, the AI/ML system 108 can determine that the data features 200 are not duplicative (e.g., represent different airports) or may only be unable to determine that the data features 200 are not definitely duplicative (e.g., and additional analysis may be required before deciding that the data features 200 are or are not duplicative).

As another example, the natural keys for the terminal waypoint group of data features 200 can be or can include the ARINC areas, the airport identifications or codes, the ICAO regions, the waypoint identifiers, or the ICAO region of the waypoint. One or more of these areas or codes may be included in the data features 200 and can be compared to each other to determine if there is a match. For example, if the natural keys for the data features 200 in different data sets 102 are in the same ARINC area, have the same airport code, are in the same ICAO region of the same airport, have the same waypoint identifier, or are in the same ICAO region, then the AI/ML system 108 may determine that the data features 200 are duplicative (e.g., represent the same waypoint). Otherwise, the AI/ML system 108 can determine that the data features 200 are not duplicative (e.g., represent different waypoints) or may only be unable to determine that the data features 200 are not definitely duplicative (e.g., and additional analysis may be required before deciding that the data features 200 are or are not duplicative).

In another example, the natural keys for the runway group of data features 200 can be or can include the ARINC areas or tailoring codes, the airport identifiers or codes, the ICAO region of the airport, the runway identifiers (e.g., runway designation, runway alignment or direction, or the landing area surface material code), etc. One or more of these areas, codes, or identifiers may be included in the data features 200 and can be compared to each other to determine if there is a match. For example, if the natural keys for the runway data features 200 in different data sets 102 are in the same ARINC area, are in the same ICAO region, have the same runway designation, have the same runway alignment, have the same code for the landing area surface material, etc., then the AI/ML system 108 may determine that the runway data features 200 are duplicative (e.g., represent the same runway). Otherwise, the AI/ML system 108 can determine that the data features 200 are not duplicative (e.g., represent different runways) or may only be unable to determine that the data features 200 are not definitely duplicative (e.g., and additional analysis may be required before deciding that the data features 200 are or are not duplicative).

As another example, the natural keys for the airway group of data features 200 can be or can include the ARINC areas or tailoring codes, route identifiers, airway segment sequence numbers, fix identifiers (e.g., a geographic location of a waypoint or navaid that is linked or associated with a route segment identifier), or an ICAO region of the geographic location or locations of the airway. If the natural keys for the airway group of data features 200 in different data sets 102 are in the same ARINC area or ICAO region, and/or have the same route identifiers, fix identifiers, or airway segment sequence numbers, then the AI/ML system 108 may determine that the airway data features 200 are duplicative (e.g., represent the same airway). Otherwise, the AI/ML system 108 can determine that the data features 200 are not duplicative (e.g., represent different airways) or may only be unable to determine that the data features 200 are not definitely duplicative (e.g., and additional analysis may be required before deciding that the data features 200 are or are not duplicative).

The AI/ML system 108 additionally or alternatively may examine the locations of the data features 200 in different data sets 102 to determine whether the data features 200 are duplicative or different. For example, the AI/ML system 108 may examine ownership of the things (e.g., airports, runways, terminal waypoints, airways, etc.) to determine whether the data features 200 are or are not duplicates. The same feature can be represented by data features 200 having different UUIDs or natural keys. Therefore, an additional technique or method to identify duplicates may be needed. The AI/ML system 108 can use a geographical algorithm to identify duplicate data features 200 or rule out data features 200 as being duplicates.

For example, the data features 200 can include geospatial coordinates, and the AI/ML system 108 can detect duplicates based on a geographical filtering by defining a three-dimensional volumes and determining whether the geospatial coordinates of compared data features 200 are within the same volume. The volumes can be referred to as tolerance volumes or ownership volumes. Differently sized and/or shaped volumes can be defined for different types or groups of data features 200. For example, for data features 200 of navaids, airports, heliports, or other significant points or locations, the AI/ML system 108 can define a sphere as the tolerance volume of ownership volume. The center of the sphere can be the geospatial coordinates of one of the data features 200 being compared (or a sphere can be defined for each of the data features 200, with the geospatial coordinates of each data feature 200 being the center of the corresponding sphere). The radius of the sphere can be a tolerance value as described herein.

If the geospatial coordinates of the data features 200 being compared are within the sphere(s), then the AI/ML system 108 can decide that the data features 200 are duplicative (e.g., represent the same navaid, airport, heliport, or other point or location). If the geospatial coordinates of the data features 200 being compared are not within the sphere(s), then the AI/ML system 108 can decide that the data features 200 are not duplicative (e.g., do not represent the same navaid, airport, heliport, or other point or location).

For data features 200 of routes, holding patterns, or airways, the AI/ML system 108 can define a cylinder as the tolerance volume of ownership volume. The center of the cylinder can be the geospatial coordinates of one of the data features 200 being compared (or a cylinder can be defined for each of the data features 200, with the geospatial coordinates of each data feature 200 being the center of the corresponding cylinder). The radius and length (or height) of the cylinder can be a tolerance value as described herein.

If the geospatial coordinates of the data features 200 being compared are within the cylinder(s), then the AI/ML system 108 can decide that the data features 200 are duplicative (e.g., represent the same navaid, airport, heliport, or other point or location). If the geospatial coordinates of the data features 200 being compared are not within the cylinder(s), then the AI/ML system 108 can decide that the data features 200 are not duplicative (e.g., do not represent the same navaid, airport, heliport, or other point or location).

For data features 200 of restriction areas, airspaces, or runways, the AI/ML system 108 can define an orthohedron as the tolerance volume of ownership volume. The center of the orthohedron can be the geospatial coordinates of one of the data features 200 being compared (or an orthohedron can be defined for each of the data features 200, with the geospatial coordinates of each data feature 200 being the center of the corresponding orthohedron). The smallest distance from the center of the orthohedron to each plane of the orthohedron can be a tolerance value as described herein.

If the geospatial coordinates of the data features 200 being compared are within the orthohedron(s), then the AI/ML system 108 can decide that the data features 200 are duplicative (e.g., represent the same navaid, airport, heliport, or other point or location). If the geospatial coordinates of the data features 200 being compared are not within the orthohedron(s), then the AI/ML system 108 can decide that the data features 200 are not duplicative (e.g., do not represent the same navaid, airport, heliport, or other point or location).

The tolerance value of the tolerance volume or ownership volume for a data feature 200 can depend on the type of the data features 200, the geospatial coordinates of the data feature 200, and/or the phase of flight of the aircraft when or while the data feature 200 is used. The tolerance value may be larger during an en-route phase of flight, while the tolerance value may be smaller during flight in terminal areas (e.g., during departure and arrival procedures of the flight), and even smaller during flight in final approach areas and while in an airport itself.

Where data features 200 are found to be duplicates, the AI/ML system 108 can examine the sources 104 of the data sets 102 containing the duplicative data features 200 to decide which of the data features 200 to use in aerospace navigation data 110 that is distributed to consumers 112 (e.g., consumers 112A-C), such as airports, air traffic controllers, pilots, etc. The data features 200 that are not selected for distribution can be left out of the navigation data 110. The AI/ML system 108 can decide which of the duplicate data features 200 to include in the navigation data 110 based on the source 104 and the locations of the data features 200.

If a data feature 200 being compared with another data feature 200 is geographically located in the same country as the source 104, then that data feature 200 may be selected by the AI/ML system 108 for use. For example, first and second data features 200A, B can represent waypoints located in France. The first data feature 200A may be in a first data set 102A provided by a first source 104A that also is located in France. The second data feature 200B may be in a second data set 102B provided by a second source 104B that is not located in France (e.g., Switzerland). The AI/ML system 108 may select the first data feature 200A due to the second data feature 200B being from another source 104B that is not located in the same country as the data feature 200.

The preceding search for and analysis of duplicative data features 200 can be time-consuming and laborious considering the vast amount of information included in the data sets 104. Combined with more frequent updates and released of this information, the searching for and analysis of the information may be too much to be able to be mentally performed in time for usage of the information in scheduling and controlling flights. The AI/ML system 108 can learn and be trained from prior decisions regarding identification and harmonization (or handling) of duplicative data features 200. This can greatly speed up both the analysis of the data sets 102 as well as the distribution of harmonized navigation data 110.

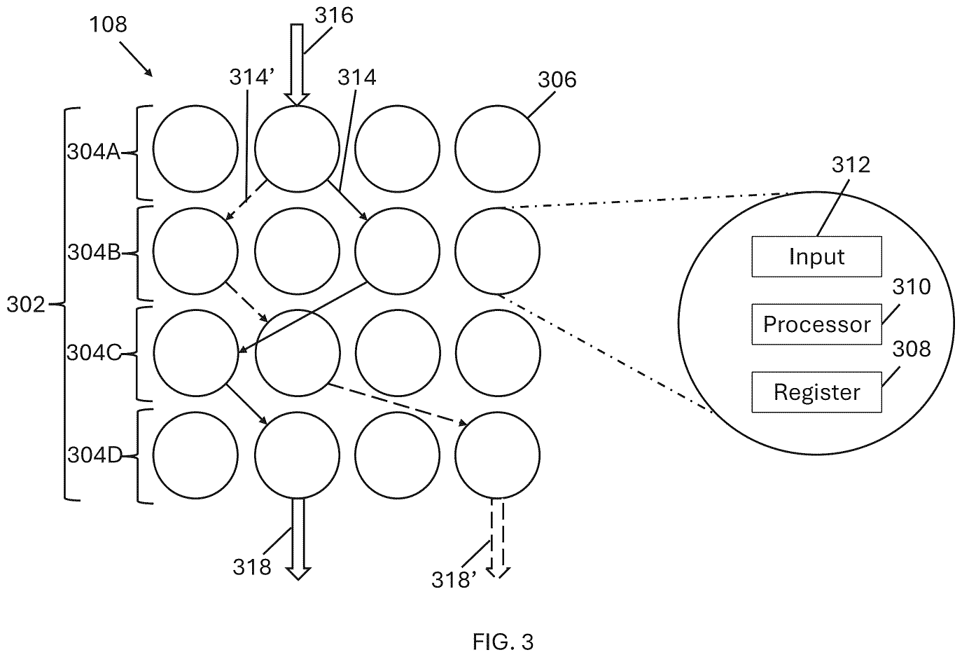

FIG. 3 illustrates one example of the ML/AI system 108 shown in FIG. 1. The ML/AI system 108 can be embodied in one or more application-specific integrated circuits (ASICs) for an artificial neural network (ANN). The ML/AI system 108 (or the ASIC(s)) can includes a series 302 of layers 304A-D, each comprising one or more artificial neurons 306 arranged in one or more neuron arrays or arrangements. While four neurons 306 are shown in each layer 304A-D and four layers 304A-D are shown, alternatively, a different number of neurons 306 may be in one or more of the layers 304A-D and/or there may be a different number of layers 304A-D.

The ML/AI system 108 may include the neurons 306 arranged in an input layer 304A, an output layer 304D, and two or more fully connected hidden or intermediate layers 304B, 304C between the input and output layers 304A, 304D. Each neuron 306 can include or represent a register 308, a microprocessor 310, and at least one input 312. The neurons 306 can generate outputs based on one or more activation functions. The neurons 306 can receive input from another neuron 306 (e.g., the output from one neuron 306 can be the input for another neuron 306). This input also can include a set of weights. The neurons 306 can be connected with each other via synaptic circuits 314, 314'. The synaptic circuits 314, 314′ can include or represent memories for storing synaptic weights.

One or more neurons 306 in the input layer 304A of the ML/AI system 108 can receive an input 316 into the ML/AI system 108. These neurons 306 can receive this input via the input(s) 312 of those neurons 306 in the input layer 304A. The neurons 306 receive the input, apply one or more mathematical equations or relationships stored in the registers 308 (and that include the weights) to generate an output. The processors 310 of the neurons 306 apply the equations/relationships and can pass the output to another neuron 306 in the same layer 304A or in a different layer 304B, 304C. The output from one neuron 306 is passed along a synaptic circuit 314 to another neuron 306 and is used as input to this other neuron 306. This process continues until one or more neurons 306 in the output layer 304D generate an output 318 from the ML/AI system 108. The synaptic circuits 314, 314′, weights stored in the synaptic circuits 314, 314′, and/or the mathematical relationships between the neurons 306 can define a model that is used to identify duplicative data features 200 from among several data sets 102 and harmonize the duplicative data features 200 as described herein.

In one example, the AI/ML system 108 can train several models for different types of the data features 200. The AI/ML system 108 may train and use one model for harmonizing airport data features 200, another model for harmonizing terminal waypoint data features 200, and so on. The AI/ML system 108 may be a long short-term memory network, recurrent neural network model trained using backpropagation through time that overcomes the vanishing gradient problem. Older data features 200 may be used to train the model(s) of the AI/ML system 108, with newer data features 200 used for validation.

During training of the AI/ML system 108, labeled data may be provided as input 316 to the AI/ML system 108. The labeled data can include prior data features 200. The neurons 306 process the input data as described above to generate the training output of the AI/ML system 108. This training output can be identifications of which data features 200 are duplicative, which data features 200 are not duplicative, the selection of which duplicative data feature 200 is included in the aerospace navigation data 110, or the like. This output can then be compared to which data features 200 were found to be duplicative (e.g., by a human analyst), which data features 200 were found to not be duplicative, which duplicative data features 200 were selected for inclusion in prior navigation data 110, or the like.

Feedback can be provided to the AI/ML system 108 in the form of a calculated error or other indication of the differences between the identified duplicates, the selected duplicates, or the like. Based on this error, the neurons 306 can change one or more of the synaptic circuits 314 that connect the neurons 306, the weights applied by one or more of the neurons 306, and/or the mathematical relationships between the neurons 306. For example, some synaptic circuits 314 can be changed to modified synaptic circuits 314′ such that the same input 316 would result in different neurons 306 receiving input and passing output to other neurons and generating a different output 318′ from the AI/ML system 108. These changes can include modifying the tolerance values, shapes of tolerance volumes used for different types of data features 200, the natural keys used to identify duplicate data features 200, or the like. The different tolerance values, different shapes of tolerance volumes, different natural keys, etc. may be represented by the different weights and relationships between the neurons 306. As a result, changing one or more of these weights or relationships (e.g., synaptic circuits 314, 314') also can change one or more of the tolerance values, the tolerance volume shape that is used for a type of data feature 200, which natural keys are examined to identify duplicative data features 200, or the like.

After training the AI/ML system 108, the AI/ML system 108 can use the trained model(s) to generate and output harmonized navigation data 110. During post-training iterations of operation of the AI/ML system 108, additional feedback can be provided to the AI/ML system 108 based on errors in identification of duplicative data features 200. For example, after training, an analyst may spot check the navigation data 110 and/or data features 200 and provide feedback to the AI/ML system 108. The AI/ML system 108 can repeatedly receive such feedback, modify one or more weights and/or synaptic circuits, etc. so that the AI/ML system 108 repeatedly changes to improve and reduce error.

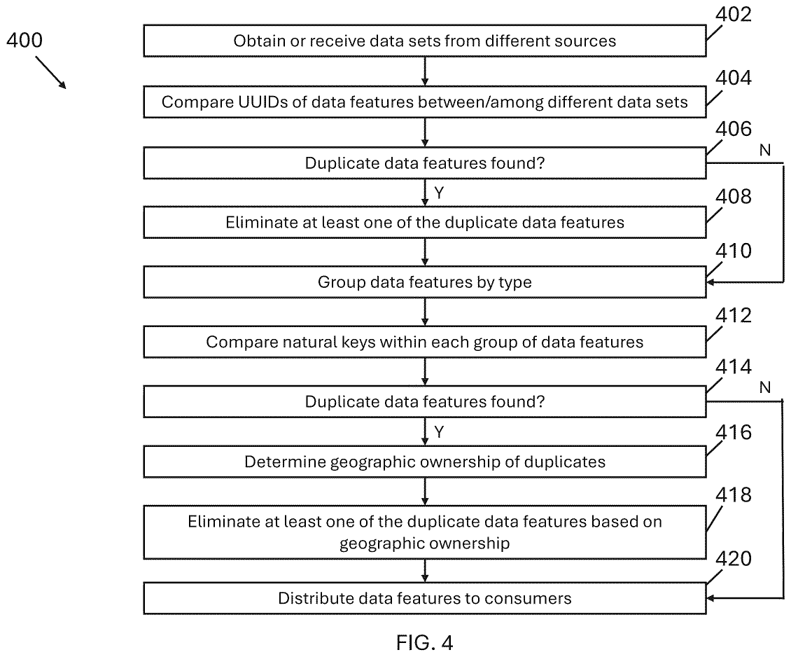

FIG. 4 illustrates a flowchart of one example of a method 400 for harmonizing aerospace navigation data. The method 400 can represent one or more operations performed by the AI/ML system 108. At 402, data sets of aerospace navigation data are obtained from different providers. At 414, unique identifiers of data features in the data sets are compared to each other to identify duplicate identifiers. For example, the UUIDs in the different data sets can be compared with each other. At 406, a decision is made as to whether identifiers are duplicated in two or more of the data sets. If any duplicates are found, then flow of the method 400 can proceed toward 408. Otherwise, flow of the method 400 can proceed toward 410.

At 408, at least one of the identified duplicate data features is eliminated. For example, if two or more data features for the same heliport are identified, then the most recently updated data feature may be retained while the older data feature is eliminated. As another example, the data feature from the source that is in the same country as the thing represented by the data feature is kept while the other duplicative data feature is eliminated. As another example, the AI/ML system 108 can learn which data feature to keep based on past decisions.

At 410, the data features (or remaining data features) are grouped by type. For example, all data features associated with airports are placed into one group, all data features associated with terminal waypoints are placed into another group, and so on. At 412, natural keys of the data features in the same group are compared. At 414, a decision is made as to whether the natural keys of the compared data features in each of the groups indicate a match (i.e., that two or more data features are duplicated in different data sets). If duplicate data features are found by examining the natural keys, then flow of the method 400 can proceed toward 416. Otherwise, flow of the method 400 can proceed toward 420.

At 416, geographic ownership of each of the duplicate data features is determined. The geographic ownership can be an identification of the country in which the thing represented by a data feature is located. For example, for a data feature indicating a runway, the country in which the runway is located is the geographic ownership of that data feature. At 418, at least one of the duplicate data entries is eliminated based on the geographic ownership. For example, the duplicate data entry that is from a source in one country, while the location represented by the duplicate data entry is in another country, may be eliminated.

At 420, the data features are distributed to data consumers, such as air traffic control, pilots, or the like. These data features may be those that are not duplicates, or those that are duplicates but that were not eliminated. Although not shown in the flowchart of FIG. 4, the method 400 optionally can include using the data features to fly an aircraft, schedule flights of aircraft, or the like.

Further, the disclosure comprises examples according to the following clauses:
Clause 1: An ASIC for an ANN, the ASIC comprising: neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to: receive data sets from different providers, the data sets including data features representative of locations used in connection with flying aircraft; examine the data features using the synaptic weights and the synaptic circuits to identify duplicative data features among the data features from the data sets; select one or more of the duplicative data features for elimination from the data sets based on prior selections of the duplicative data features; and send remaining data features other than the one or more of the duplicative data features selected for elimination to one or more data consumers for use in flying or managing flight of one or more aircraft.
Clause 2: The ASIC of Clause 1, wherein the data features represent one or more airports, helipads, runway locations, waypoints, terminal points, holding patterns, airspaces, airway locations, or airway layouts.
Clause 3: The ASIC of Clause 1, wherein the synaptic weights and the synaptic circuits are trained to select the one or more of the duplicative data features for elimination based on the prior selections of the duplicative data features by one or more human analysts.
Clause 4: The ASIC of Clause 1, wherein the data sets are received from the providers in different countries, and the one or more of the duplicative data features are selected for elimination based on geographic ownership of the duplicative data features.
Clause 5: The ASIC of Clause 4, wherein the processing elements of the neurons also are configured to: identify geographic locations of the duplicative data features; identify countries from which the providers of the data sets including the duplicative data features are located; and determine the geographic ownership of the duplicative data features based on the geographic locations and the countries that are identified.
Clause 6: The ASIC of Clause 1, wherein the duplicative data features are identified by comparing one or both of universally unique identifiers or natural keys of the duplicative data features with each other.
Clause 7: The ASIC of Clause 1, wherein the providers from which the data sets are received are air navigation service providers.
Clause 8: A method comprising: receiving data sets from different providers, the data sets including data features representative of locations used in connection with flying aircraft; examining the data features using one or more ASICs for an ANN, the one or more ASICs including neurons organized in an array, each of the neurons including a register, a processing element, and at least one input, the one or more ASICs also including synaptic circuits, each of the synaptic circuits including a memory for storing a synaptic weight, wherein each of the neurons is connected to at least one other of the neurons via at least one of the synaptic circuits, the data features examined using the synaptic weights and the synaptic circuits to identify duplicative data features among the data features from the data sets; selecting one or more of the duplicative data features for elimination from the data sets based on prior selections of the duplicative data features; and sending remaining data features other than the one or more of the duplicative data features selected for elimination to one or more data consumers for use in flying or managing flight of one or more aircraft.
Clause 9: The method of Clause 8, wherein the data features represent one or more airports, helipads, runway locations, waypoints, terminal points, holding patterns, airspaces, airway locations, or airway layouts.
Clause 10: The method of Clause 8, further comprising: modifying one or more of the synaptic weights or the synaptic circuits during training to select the one or more of the duplicative data features for elimination based on the prior selections of the duplicative data features by one or more human analysts.
Clause 11: The method of Clause 8, wherein the data sets are received from the providers in different countries, and the one or more of the duplicative data features are selected for elimination based on geographic ownership of the duplicative data features.
Clause 12: The method of Clause 11, further comprising: identifying geographic locations of the duplicative data features; identifying countries from which the providers of the data sets including the duplicative data features are located; and determining the geographic ownership of the duplicative data features based on the geographic locations and the countries that are identified.
Clause 13: The method of Clause 8, wherein the duplicative data features are identified by comparing one or both of universally unique identifiers or natural keys of the duplicative data features with each other.
Clause 14: The method of Clause 8, wherein the providers from which the data sets are received are air navigation service providers.
Clause 15: The method of Clause 8, further comprising: receiving feedback indicative of differences between selection of the one or more of the duplicative data features for elimination by the one or more ASICs and selection of the one or more of the duplicative data features by one or more human analysts; and modifying one or more of the synaptic weights or the synaptic circuits based on the feedback that is received.
Clause 16: An artificial intelligence system comprising: one or more ASICs, each of the ASICs comprising: neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits, the processing elements of the neurons configured to: receive data sets from different providers, the data sets including data features representative of locations used in connection with flying aircraft; examine the data features using the synaptic weights and the synaptic circuits to identify duplicative data features among the data features from the data sets; select one or more of the duplicative data features for elimination from the data sets based on prior selections of the duplicative data features by one or more analysts; and send remaining data features other than the one or more of the duplicative data features selected for elimination to one or more data consumers for use in flying or managing flight of one or more aircraft.
Clause 17: The artificial intelligence system of Clause 16, wherein the data features represent one or more airports, helipads, runway locations, waypoints, terminal points, holding patterns, airspaces, airway locations, or airway layouts.
Clause 18: The artificial intelligence system of Clause 16, wherein the synaptic weights and the synaptic circuits are trained to select the one or more of the duplicative data features for elimination based on the prior selections of the duplicative data features by one or more human analysts.
Clause 19: The artificial intelligence system of Clause 16, wherein the data sets are received from the providers in different countries, and the one or more of the duplicative data features are selected for elimination based on geographic ownership of the duplicative data features.
Clause 20: The artificial intelligence system of Clause 19, wherein the processing elements of the neurons also are configured to: identify geographic locations of the duplicative data features; identify countries from which the providers of the data sets including the duplicative data features are located; and determine the geographic ownership of the duplicative data features based on the geographic locations and the countries that are identified.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An application-specific integrated circuit (ASIC) for an artificial neural network (ANN), the ASIC comprising:
neurons organized in an array, each of the neurons including a register, a processing element, and at least one input; and
synaptic circuits, each of the synaptic circuits including a memory for storing a synaptic weight, wherein each of the neurons is connected to at least one other of the neurons via at least one of the synaptic circuits, the processing elements of the neurons configured to:
receive data sets from different providers, the data sets including data features representative of locations used in connection with flying aircraft;
examine the data features using the synaptic weights and the synaptic circuits to identify duplicative data features among the data features from the data sets;
select one or more of the duplicative data features for elimination from the data sets based on prior selections of the duplicative data features; and
send remaining data features other than the one or more of the duplicative data features selected for elimination to one or more data consumers for use in flying or managing flight of one or more aircraft.

2. The ASIC of claim 1, wherein the data features represent one or more airports, helipads, runway locations, waypoints, terminal points, holding patterns, airspaces, airway locations, or airway layouts.

3. The ASIC of claim 1, wherein the synaptic weights and the synaptic circuits are trained to select the one or more of the duplicative data features for elimination based on the prior selections of the duplicative data features by one or more human analysts.

4. The ASIC of claim 1, wherein the data sets are received from the providers in different countries, and the one or more of the duplicative data features are selected for elimination based on geographic ownership of the duplicative data features.

5. The ASIC of claim 4, wherein the processing elements of the neurons also are configured to:
identify geographic locations of the duplicative data features;
identify countries from which the providers of the data sets including the duplicative data features are located; and
determine the geographic ownership of the duplicative data features based on the geographic locations and the countries that are identified.

6. The ASIC of claim 1, wherein the duplicative data features are identified by comparing one or both of universally unique identifiers or natural keys of the duplicative data features with each other.

7. The ASIC of claim 1, wherein the providers from which the data sets are received are air navigation service providers.

8. A method comprising:
receiving data sets from different providers, the data sets including data features representative of locations used in connection with flying aircraft;
examining the data features using one or more application-specific integrated circuits (ASIC) for an artificial neural network (ANN), the one or more ASICs including neurons organized in an array, each of the neurons including a register, a processing element, and at least one input, the one or more ASICs also including synaptic circuits, each of the synaptic circuits including a memory for storing a synaptic weight, wherein each of the neurons is connected to at least one other of the neurons via at least one of the synaptic circuits, the data features examined using the synaptic weights and the synaptic circuits to identify duplicative data features among the data features from the data sets;
selecting one or more of the duplicative data features for elimination from the data sets based on prior selections of the duplicative data features; and
sending remaining data features other than the one or more of the duplicative data features selected for elimination to one or more data consumers for use in flying or managing flight of one or more aircraft.

9. The method of claim 8, wherein the data features represent one or more airports, helipads, runway locations, waypoints, terminal points, holding patterns, airspaces, airway locations, or airway layouts.

10. The method of claim 8, further comprising:
modifying one or more of the synaptic weights or the synaptic circuits during training to select the one or more of the duplicative data features for elimination based on the prior selections of the duplicative data features by one or more human analysts.

11. The method of claim 8, wherein the data sets are received from the providers in different countries, and the one or more of the duplicative data features are selected for elimination based on geographic ownership of the duplicative data features.

12. The method of claim 11, further comprising:
identifying geographic locations of the duplicative data features;
identifying countries from which the providers of the data sets including the duplicative data features are located; and
determining the geographic ownership of the duplicative data features based on the geographic locations and the countries that are identified.

13. The method of claim 8, wherein the duplicative data features are identified by comparing one or both of universally unique identifiers or natural keys of the duplicative data features with each other.

14. The method of claim 8, wherein the providers from which the data sets are received are air navigation service providers.

15. The method of claim 8, further comprising:
receiving feedback indicative of differences between selection of the one or more of the duplicative data features for elimination by the one or more ASICs and selection of the one or more of the duplicative data features by one or more human analysts; and
modifying one or more of the synaptic weights or the synaptic circuits based on the feedback that is received.

16. An artificial intelligence system comprising:
one or more application-specific integrated circuits (ASIC), each of the ASICs comprising:
neurons organized in an array, each of the neurons including a register, a processing element, and at least one input; and
synaptic circuits, each of the synaptic circuits including a memory for storing a synaptic weight, wherein each of the neurons is connected to at least one other of the neurons via at least one of the synaptic circuits, the processing elements of the neurons configured to:
receive data sets from different providers, the data sets including data features representative of locations used in connection with flying aircraft;
examine the data features using the synaptic weights and the synaptic circuits to identify duplicative data features among the data features from the data sets;
select one or more of the duplicative data features for elimination from the data sets based on prior selections of the duplicative data features by one or more analysts; and
send remaining data features other than the one or more of the duplicative data features selected for elimination to one or more data consumers for use in flying or managing flight of one or more aircraft.

17. The artificial intelligence system of claim 16, wherein the data features represent one or more airports, helipads, runway locations, waypoints, terminal points, holding patterns, airspaces, airway locations, or airway layouts.

18. The artificial intelligence system of claim 16, wherein the synaptic weights and the synaptic circuits are trained to select the one or more of the duplicative data features for elimination based on the prior selections of the duplicative data features by one or more human analysts.

19. The artificial intelligence system of claim 16, wherein the data sets are received from the providers in different countries, and the one or more of the duplicative data features are selected for elimination based on geographic ownership of the duplicative data features.

20. The artificial intelligence system of claim 19, wherein the processing elements of the neurons also are configured to:
identify geographic locations of the duplicative data features;
identify countries from which the providers of the data sets including the duplicative data features are located; and
determine the geographic ownership of the duplicative data features based on the geographic locations and the countries that are identified.
